(19) United States
(12) Patent Application Publication
(10) Pub. No.: US 2022/0318654 A1
(43) Pub. Date: Oct. 6, 2022

(54) Machine Learning and Reject Inference Techniques Utilizing Attributes of Unlabeled Data Samples

(71) Applicant: PayPal, Inc., San Jose, CA (US)

(72) Inventors: Ying Lin, Shanghai (CN); Jiadong Chen, Shanghai (CN); Jiaqi Zhang, Shanghai (CN); Lidong Ge, Shanghai (CN)

(21) Appl. No.: 17/455,548

(22) Filed: Nov. 18, 2021

(30) Foreign Application Priority Data
Mar. 30, 2021 (CN) PCT/CN2021/083950

(51) Int. Cl. G06N 5/04

(52) U.S. Cl. CPC G06N 5/04

(57) ABSTRACT

The present disclosure relates to machine learning related reject inference techniques that utilize attributes of unlabeled data samples. Specifically, the present techniques allow for machine learning based classification of data that might otherwise not be classifiable using another type of classification algorithm. This can improve computer efficiency and security. A computer system may process unlabeled data samples, using a classification model, to generate a plurality of model scores. The computer system may then classify a first unlabeled data sample into one of two categories. This classifying can include selecting a set of unlabeled data samples, from the plurality of unlabeled data samples, that have model scores exceeding a threshold, identifying a plurality of attributes of the set of unlabeled data samples that contributed to the model scores exceeding the particular threshold, and, based on the plurality of attributes, generating a new labeled data sample belonging to a particular category.

### PRIORITY CLAIM

The present application claims priority to PCT Appl. No. PCT/CN2021/083950, filed Mar. 30, 2021, which is incorporated by reference herein in its entirety.

### BACKGROUND

### Technical Field

This disclosure relates generally to machine learning and data science, and more particularly to reject inference techniques that utilize attributes of unlabeled data samples to increase the size of a training dataset. These techniques allow for more effective categorization of data samples in a machine learning context, according to various embodiments.

### Description of the Related Art

A server system may utilize various techniques to identify user accounts in its user-base that are malicious user accounts that may attempt to circumvent computer security mechanisms or otherwise perform malicious activity. One technique for identifying malicious user accounts is to use a classification model to classify a user account as malicious or not malicious based on activity associated with that user account. This technique suffers from various technical problems, however. For example, in many instances, there may be a significant number of dormant user accounts that have little to no history of activity (or little to no recent activity), making these dormant user accounts difficult to classify using such a classification model. Applicant recognizes that, within this set of dormant accounts, it is likely that some are malicious user accounts and that identifying at least a subset of these dormant malicious user accounts is desirable for improving computer security and functionality.

### BRIEF DESCRIPTION OF THE DRAWINGS

FIG. 1 is a block diagram illustrating an example reject inference module, according to some embodiments.

FIGS. 2A-2B depict pie charts representing the composition of a training dataset before and after use of the disclosed reject inference techniques, according to some embodiments.

FIG. 3 is a block diagram illustrating an example reject inference module that includes an attribute selection module and a rule generation module, according to some embodiments.

FIG. 4 is a block diagram illustrating an example reject inference module that includes a rule verification module and a rule selection module, according to some embodiments.

FIG. 5 is a block diagram illustrating a portion of an expanded training dataset, according to some embodiments.

FIG. 6 is a flow diagram illustrating an example method for performing reject inference using attributes of unlabeled data samples, according to some embodiments.

FIG. 7 is a flow diagram illustrating an example method for identifying malicious dormant user accounts using the disclosed reject inference techniques, according to some embodiments.

FIG. 8 is a block diagram illustrating an example computer system, according to some embodiments.

### DETAILED DESCRIPTION

Generally, this disclosure discusses techniques that allow for better classification of data items in machine learning contexts, according to various embodiments. These techniques can be used in some embodiments when a set of data corresponding to something is to be classified. Many examples below are discussed in terms of classifying user accounts, e.g., as a (potentially) malicious account or a non-malicious account. These techniques are expressly not limited to these examples, but may be generalized for other machine learning related classification tasks as well (e.g., any scenario where a machine learning score is provided and/or a machine learning classifier is used to determine a category from a plurality of possible categories for something).

A server system may utilize various techniques to identify user accounts in its user-base that are malicious user accounts. As used herein, a malicious user account refers to a user account that is being used, or likely will be used, to perform fraudulent or otherwise malicious activities. One technique for identifying malicious user accounts is to use a classification model (e.g., a machine learning model implemented using an artificial neural network (“ANN”)) to classify a user account as malicious or not malicious based on activity associated with that user account. For example, to classify a given user account, a feature vector specifying various attributes associated with the user account may be provided as input to the classification model, which may predict the probability that the corresponding user account is malicious. If that probability value (also referred to herein as a “model score” in various embodiments) exceeds a certain threshold value, that user account may be classified as a malicious account and, if not, the user account may be classified as not malicious (e.g., a user account that likely is not being used, or likely will not be used, to perform fraudulent or otherwise malicious activities). If an account is classified as malicious, the server system may then take one or more protective actions (e.g., requiring multi-factor authentication for the account, disabling certain functionality for the account, etc.).

The training dataset used to train such a classification model may include labeled training data corresponding to active user accounts that have already been classified as malicious or not malicious based on the activity associated with those accounts. In many instances, however, a significant portion (e.g., 40%, 50%, 60%, etc.) of the user accounts with the server system are dormant accounts that have not been accessed or used for an extended time period or since their initial creation. In this disclosure, the term “dormant user account” is used broadly to refer to a user account that has not been used to perform one or more specified activities (e.g., log in to the account, perform an electronic transaction via the account, etc.) within a threshold period of time (e.g., 3 months, 6 months, etc.). Applicant recognizes that, within the set of dormant accounts, it is likely that some of these user accounts are malicious accounts that will be used to engage in fraudulent or otherwise malicious activity in the future. Since these dormant user accounts have little to no history of activity, however, these dormant accounts are often difficult to classify using prior techniques.

In many instances, identifying at least some of these dormant malicious accounts may provide various technical benefits. For example, adding new labeled training samples corresponding to these identified dormant malicious accounts to the training dataset expands the size of the training dataset, which, in turn, may improve the performance of the classification model (or any other model) trained using that training dataset. Expanding the training dataset using training samples for the dormant malicious accounts may be particularly advantageous in the scenario noted above in which a significant portion of the user accounts are dormant. Consider, as a non-limiting example, an instance in which 65% of the user accounts with a server system are dormant and, of the active accounts, 30% have been classified as not malicious and 5% have been classified as malicious. In this non-limiting example, if the training dataset includes samples that correspond to the active user accounts, the training dataset will be significantly imbalanced and include relatively few training samples for malicious accounts compared to not malicious accounts. This imbalance in the composition of the training dataset may negatively impact the performance of a predictive model trained with such training data. Accordingly, by adding training samples corresponding to malicious accounts, the training dataset becomes both larger and more balanced, which, as will be appreciated by one of skill in the art with the benefit of this disclosure, typically results in the models trained on such a dataset being more accurate.

This process of identifying, from a set of dormant accounts, user accounts that have a high likelihood of being malicious may be viewed as an application of “reject inference,” a technique in which data samples corresponding to an initially “rejected” population (e.g., the dormant

accounts, in the instant example) are assigned outcomes such that these data samples may be used to develop future predictive models. One possible approach to address this reject inference problem is to apply unlabeled data samples corresponding to the dormant accounts to the classification model to generate model scores for these unlabeled data samples and then to classify the unlabeled data samples having the highest model scores, and the corresponding dormant accounts, as malicious. This approach suffers from various technical shortcomings, however. For example, using this technique, there is no way to verify why a given dormant account received a high model score or was classified as malicious. Instead, this technique relies entirely on the classification model, which may be seen as a “black box” that generates a model score without providing any explanation as to the attributes of a dormant account that contribute to its classification as malicious. Further, because such a technique relies solely on the model scores to classify the dormant user accounts, there is an increased opportunity for dormant user accounts to be misclassified, which, in turn, may negatively impact the quality of the training dataset and any predictive models built based on that training dataset. For example, by adding training samples that have been incorrectly labeled as “malicious,” such a technique introduces erroneous training data into the training dataset, which may then be “learned” by a model trained thereon, reducing the model's accuracy and undermining the purpose of the reject inference process.

In various embodiments, however, the disclosed techniques solve these technical problems by performing reject inference techniques that utilize one or more attributes of the unlabeled data samples. For example, some disclosed embodiments include using a classification model that was trained using a training dataset that includes a first set of labeled data samples that are classified as belonging to a first category and a second set of labeled data samples that are classified as belonging to a second category. As a non-limiting example, in some embodiments the training dataset may correspond to active user accounts with a server system, where the first set of labeled data samples correspond to malicious user accounts in the second set of labeled data samples correspond to non-malicious user accounts. Using this classification model, the disclosed techniques may include generating model scores for unlabeled data samples, which, in a non-limiting example, correspond to dormant user accounts with the server system. In various embodiments, the disclosed techniques may then identify one or more of the unlabeled data samples to classify into one of a set of classes (e.g., into the class of malicious user accounts). For

example, the disclosed techniques may include selecting, from the group of unlabeled data samples, a set of unlabeled data samples that have model scores exceeding a particular threshold. In some embodiments, this may include selecting the set of unlabeled data samples that have the highest 5% (or any other suitable percentage value) of model scores.

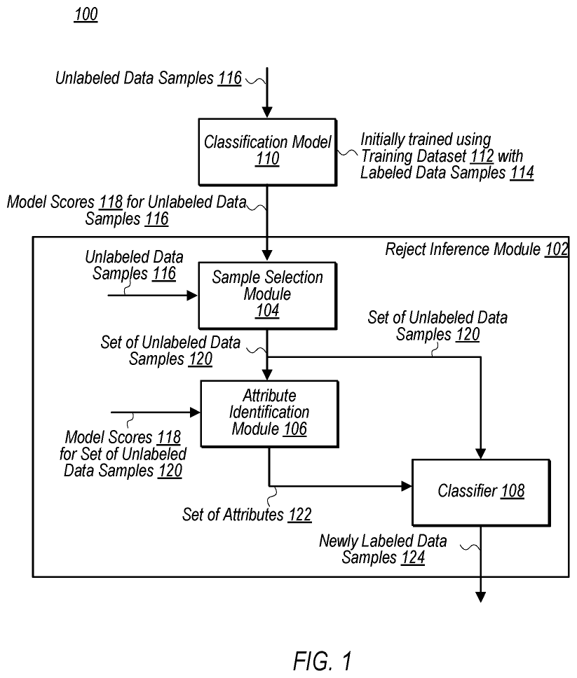

Consider, as one non-limiting example, an embodiment in which higher model scores correspond to an increased probability that a given unlabeled data sample (and its corresponding dormant user account) belongs to the classification of “malicious user accounts.” In this scenario, by selecting only those unlabeled data samples for which the model scores exceed some threshold, the disclosed techniques are identifying those samples that, per the classification model, are likely to correspond to malicious user accounts. Unlike the approach described above however, the disclosed reject inference techniques may address the various technical shortcomings discussed above. For example, various disclosed embodiments include identifying, for the set of unlabeled data samples, attributes of those unlabeled data samples that contributed to their model scores exceeding the particular threshold. These attributes are described in more detail below with reference to FIG. 1. Based on these attributes, the disclosed techniques may then identify one or more unlabeled data samples to classify into a first category. In some embodiments, for example, the disclosed techniques include applying a policy rule that is based on the most common attributes that contributed to the model scores for the set of unlabeled data samples. Once identified, these previously unlabeled data samples may be assigned a corresponding label (e.g., a value corresponding to the category in which the unlabeled data sample is being classified) and added to the training dataset. This expanded training dataset may then be used to train one or more predictive models, such as the classification model described above.

Referring now to FIG. 1, block diagram 100 depicts a reject inference module 102 that, in various embodiments, is operable to perform reject inference operations that utilize the attributes that contributed to the model scores of unlabeled data samples having high model scores. In FIG. 1, block diagram 100 depicts a classification model 110 that has been trained using a training dataset 112 with labeled data samples 114. Classification model 110 may be any of various suitable types of predictive models operable to generate a model score for a provided sample. In some embodiments, for example, classification model 110 is a machine learning model that may be implemented using an ANN. In various embodiments, the classification model 110 may be implemented using any of various suitable ANN architectures. For example, in some embodiments, a neural network may be implemented using a feed-forward neural network architecture, such as a multi-layer perceptron (“MLP”) architecture or a convolutional neural network (“CNN”) architecture, or a recurrent neural network (“RNN”), such as a long short-term memory (“LSTM”) model. Note that these specific examples are provided merely as non-limiting embodiments, however, and that, in other embodiments, the classification model 110 may be implemented using any suitable ANN architecture(s) (or combinations thereof), as desired. In embodiments in which the classification model 110 is implemented using an ANN, model 110 may be trained using any of various suitable learning algorithms (e.g., backpropagation) implemented using various suitable machine learning libraries (e.g., Scikit-learn, TensorFlow, etc.) based on the training dataset 112. Note, however, that this embodiment is provided merely as one non-limiting example and in other embodiments, classification model 110 may be implemented using any of various other machine learning algorithms.

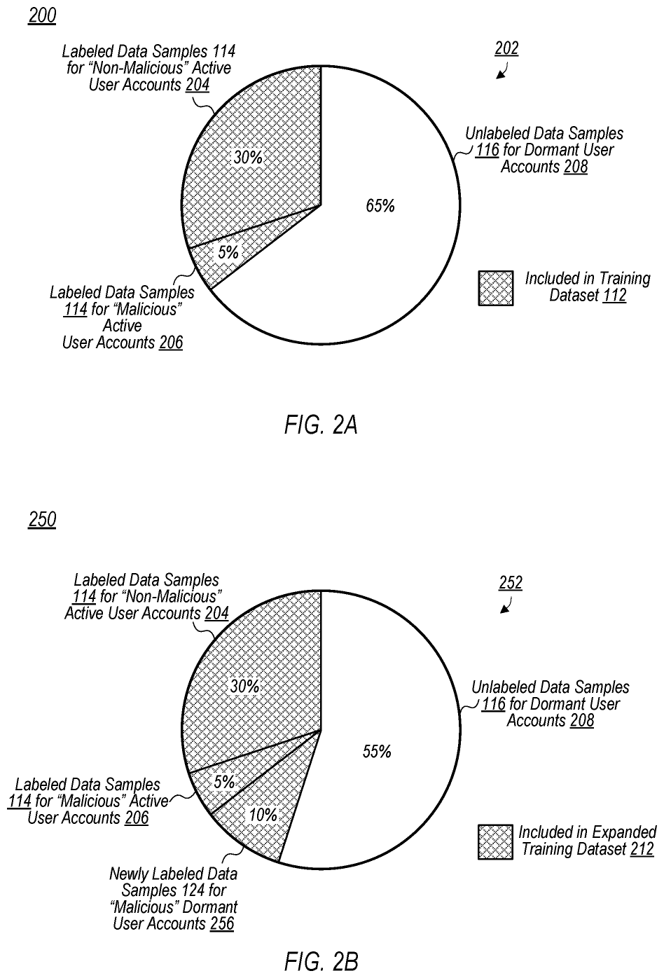

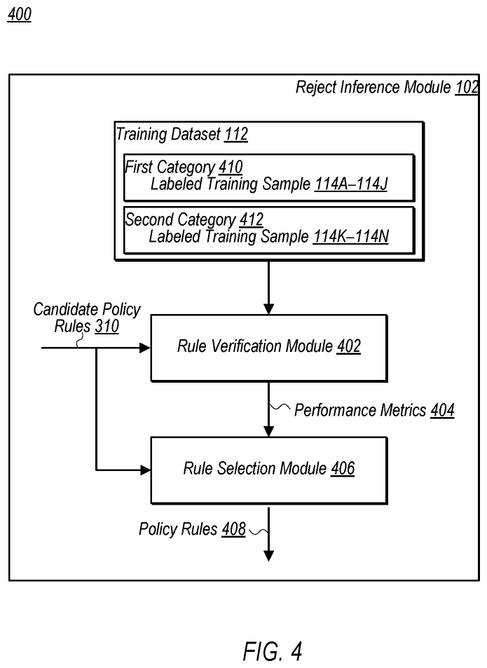

Training dataset 112, according to some non-limiting embodiments, is described in detail below with reference to FIGS. 2A-2B and 4. For the purposes of the present discussion, note that the training dataset 112 may include labeled data samples 114 that belong to multiple (e.g., two, three, four, etc.) different categories. As a non-limiting example, in some embodiments the training dataset 112 includes labeled data samples 114 that belong to one of two possible categories (e.g., “spam” or “not spam,” “malicious user accounts” or “non-malicious user accounts,” “fraudulent transactions” or “non-fraudulent transactions,” etc.). In such embodiments, the classification model 110 trained on such a training dataset 112 is a binary classification model that is operable to generate, for a new data sample, a model score indicative of the probability that the new data sample belongs to one of the two categories. In some embodiments, for example, classification model 110 may generate model scores on a scale from 0.0-1.0, with increasing values for the model score indicating an increased likelihood that the sample belongs to a particular one of the classes (e.g., the classification of “malicious user accounts”). Note, however, that this embodiment is provided merely as one non-limiting example and, in other embodiments, the classification model 110 may generate model scores that utilize any suitable scale to facilitate the mapping of model scores to one of two or more classes. For example, in some embodiments, classification model 110 may generate model scores such that lower values or values within a particular range indicate an increased likelihood that the sample belongs to a particular one of the multiple classes.

In various embodiments, classification model 110 may be used to generate model scores 118 for unlabeled data samples 116, which, in various embodiments, specify feature vectors for observations that have not yet been classified (e.g., “labeled”). Continuing with the example introduced above, in some embodiments the unlabeled data samples 116 may correspond to dormant user accounts with a server system that have not been classified as malicious or non-malicious. In other embodiments, the unlabeled data samples 116 may correspond to emails that have not yet been classified as “spam” or “not spam,” or to electronic transactions that have not yet been classified as “fraudulent” or “not fraudulent,” etc.

In FIG. 1, reject inference module 102 includes sample selection module 104, which, in some embodiments, is operable to select a set of unlabeled data samples 120, from the group of unlabeled data samples 116, based on their corresponding model scores 118. For example, in some embodiments, sample selection module 104 is operable to select the unlabeled data samples 116 having model scores that exceed a particular threshold. As one non-limiting example, in embodiments in which the model scores are generated on a scale from 0.0-1.0, sample selection module 104 may select those unlabeled data samples 116 that have a corresponding model score 118 that exceeds 0.8, 0.85, 0.95, or any other suitable threshold value. Note, however, that this embodiment is provided merely as a non-limiting example and, in other embodiments, other suitable threshold values may be used. In some embodiments, sample selection module 104 may select the unlabeled data samples 116 that have the highest model scores 118. In some such embodiments, for example, sample selection module 104 may select the unlabeled data samples 116 that have the top 1%, 2%, 3%, or any other suitable threshold of model scores 118 to include in the set of unlabeled data samples 120.

In the depicted embodiment, reject inference module 102 further includes attribute identification module 106, which in various embodiments is operable to identify a set of attributes 122 of the set of unlabeled data samples 120. In various embodiments, the attribute identification module 106 is operable to generate information indicating (either directly or indirectly) one or more of the attributes of a data sample (e.g., unlabeled data sample 116) that contributed to a model score 118 generated for that data sample. Accordingly, in various embodiments, the attribute identification module 106 is operable to determine the reasons that contributed to a given sample receiving a particular model score 118 by the classification model 110.

As will be appreciated by one of skill in the art, the term “feature vector” refers to a set of data values (e.g., a 1×N array of values) that correspond to attributes (also referred to herein as “features”) of a given data sample (e.g., unlabeled data sample 116). The nature of the attributes included in a feature vector for a given data sample will vary depending on the entity the data sample is used to represent. As a non-limiting example, consider again the scenario in which the disclosed reject inference module 102 is used to identify malicious dormant user accounts with a server system based on the unlabeled data samples 116 that correspond to these dormant accounts. In this context, the data samples (e.g., unlabeled data samples 116 or labeled data samples 114) represent user accounts with the server system. In this example embodiment, the feature vector for a given data sample may include various attributes of the account that were gathered at the time the account was created or based on activity associated with the account (e.g., prior to the cessation of use of the account). Non-limiting examples of attributes may include: an email address, type of device used to access the account, operating system of the device(s) used to access the account, browser application(s) used to access the account, time of day account was created, an IP address of the device used to create or access the user account, etc. Additionally, in some embodiments, the feature vector for a given data sample may include attributes that were derived or calculated (e.g., by the server system) rather than being directly observed. Non-limiting examples of such attributes include: a number of accounts created using the same IP address, etc. Note that, in various embodiments, the samples (e.g., labeled data samples 114 or unlabeled data samples 116) may include any suitable number (e.g., 10, 100, 1000, etc.) of attributes in their respective feature vectors. Further note that, in various embodiments, the attribute identification module 106 may identify the set of attributes 122 directly (e.g., by generating text-based output specifying the individual attributes), indirectly (e.g., as one or more codes that identify the various attributes from a list of attributes), or both.

Attribute identification module 106, in various embodiments, is operable to identify one or more of the attributes that contributed to the unlabeled data sample 116 receiving its model score 118. For example, in various embodiments, for each of the unlabeled data samples in the set 120, the attribute identification module 106 may generate a list of the attributes of the sample (e.g., ranked in order of impact) that caused or contributed to the model score 118 for that data sample. In various embodiments, attribute identification module 106 is operable to identify the attributes by learning the distribution of the classification model 110 based on a population of unlabeled data samples 116 and the corresponding model scores 118.

In some embodiments for example, for a given unlabeled data sample 116, the attribute identification module 106 creates a modified version of the given unlabeled data sample 116 by changing one of the sample 116's attributes. As one non-limiting example, if one attribute of an unlabeled data sample 116 indicates that the corresponding dormant account was created from an IP address that had never been previously used to create a different user account with the server system, the attribute identification module 106 may change this attribute to indicate that the corresponding dormant user account was created from an IP address that had previously been used to create ten different user accounts. The attribute identification module 106 may then apply the modified sample to the classification model 110 to generate a model score (e.g., model score 118′) for the modified sample and determine the amount of change to the model score for the unlabeled data sample 116 that was caused by the modification to the unlabeled data sample 116 (e.g., as a percentage difference between original model score 118 and model score 118′ for the modified sample). The attribute identification module 106 may repeat this process one or more times, tweaking different attributes of the unlabeled data sample 116 and determining how those changes affect the model score 118 for that unlabeled data sample 116. Based on this process, the attribute identification module 106 may identify (e.g., in ranked order) the attributes that most contributed to the model score 118 for a given unlabeled data sample 116. For example, modifications that resulted in larger changes in the model score 118 for a given unlabeled data sample 116 may indicate that the attribute being modified provides a larger contribution to the model score 118 relative to the sample 116's other attributes, the modification of which resulted in smaller changes to the sample 116's model score 118. The attribute identification module 106 may repeat this process for one or more of the remaining unlabeled data samples 116. In various embodiments, attribute identification module 106 is operable to identify one or more of the attributes that contributed to the model score 118 received by an unlabeled data sample 116 using the techniques described in detail in U.S. patent application Ser. No. 15/296,520 entitled “Processing Machine Learning Attributes,” which was filed on Oct. 18, 2016 and is incorporated by reference as if entirely set forth herein.

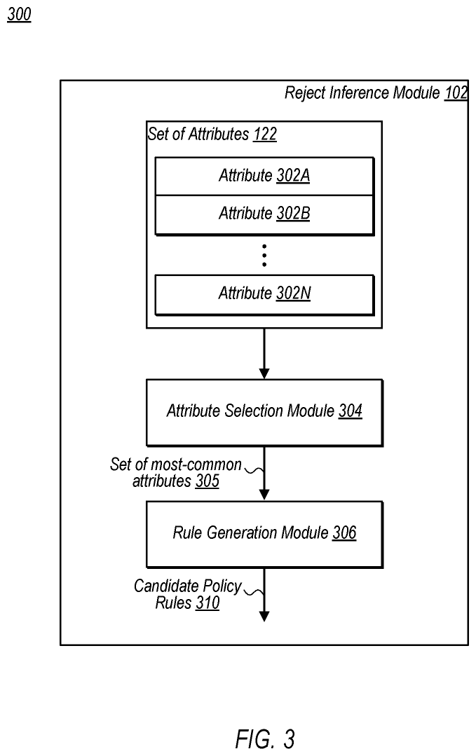

Reject inference module 102 further includes classifier 108, which in various embodiments is operable to classify one or more of the set of unlabeled data samples 120 based on the set of attributes 122 to generate one or more newly labeled data samples 124. Classifier 108, in some embodiments, utilizes one or more policy rules that are based on the set of attributions 122, as described in detail below with reference to FIG. 3. For the purposes of the present discussion, however, note that in some embodiments these policy rules are based on the most-common attributes (or combinations thereof) identified in the set of attributes 122. Using the one or more policy rules, the classifier 108 may classify one or more of the set of unlabeled data samples 120 into a particular classification. In various embodiments, the newly labeled data samples 124 identified using the classifier 108 may be assigned a classification label and added to the training dataset 112. As noted above, utilizing the disclosed reject inference techniques to generate newly labeled data samples 124 may provide various technical benefits. For example, by adding newly labeled data samples 124 to the training dataset 112, the disclosed techniques are operable to increase the size of the training dataset 112. Further, in embodiments in which, as described above, the disclosed reject inference techniques are used to identify samples belonging to a category for which there is relatively little training data, the disclosed techniques may aid in balancing the distribution of training data included in the training dataset 112, further improving the performance of the predictive models trained thereon. Further, in some embodiments, once the reject inference module 102 has identified one or more newly labeled data samples 124 the disclosed techniques may include performing one or more risk-mitigation operations on the dormant user accounts corresponding to those newly labeled data samples 124. This, in turn, may reduce the risk associated with these dormant user accounts and improve the security of the server system as a whole.

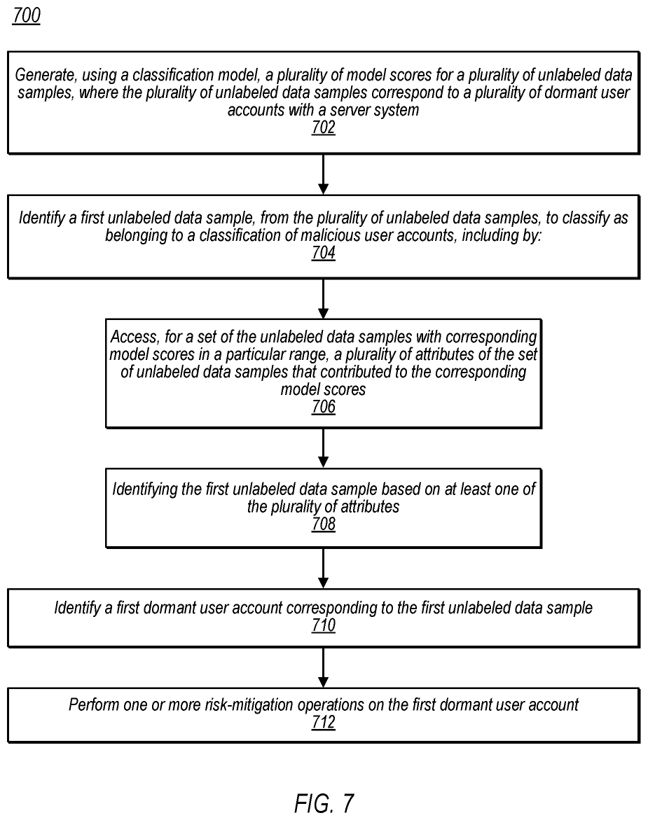

In various embodiments, the disclosed reject inference techniques provide various technical benefits. For example, unlike reject inference techniques that rely solely on a sample's model score to perform reject inference, the disclosed techniques allow policy rules to be generated based on the set of attributes 122 that were found to contribute to the unlabeled data samples 116 receiving high model scores 118, which may provide various technical benefits. For instance, the policy rules may be constructed based on the most-common attributes in the set of attributes 122, which in various embodiments may help ensure that the newly labeled data samples 124 that are added to the training dataset 112 are classified correctly. Further, since the newly labeled data samples 124 are identified based on these attributes, the reasons for which a given newly labeled data sample 124 was identified are explainable and can be readily verified. Additionally, as described in more detail below with reference to FIG. 4, in some embodiments the disclosed techniques include verifying the policy rules (e.g., using the labeled data samples 114 from the training dataset 112) before these rules are utilized in the reject inference module 102, ensuring that the policy rules selected for use meet desired performance metrics (e.g., accuracy, coverage, stability, etc.). By increasing the size of the training dataset 112 and evening out the number of training samples included in the different categories, the disclosed techniques improve the quality of the training dataset 112 and the performance of predictive models built using that training dataset 112. Further, as described in greater detail below with reference to FIG. 7, in various embodiments the disclosed reject inference techniques may be used to identify an unlabeled data sample, which corresponds to a dormant user account, to classify as a malicious dormant user account. In some such embodiments, once a malicious dormant user account has been identified, the server system may take one or more preemptive risk-mitigation operations, thereby reducing the potential security threat posed by that dormant user account and improving the data security of the server system as a whole.

Note that, although described herein in the context of identifying malicious dormant accounts, the disclosed techniques may be implemented in various different contexts. For example, in some embodiments, the disclosed techniques may be used in the context of a multiclass classification (in addition to the binary classification context described above of classifying malicious and not malicious user accounts).

Turning now to FIGS. 2A-2B, block diagrams 200 and 250 respectively depict pie charts representing the composition of a training dataset before and after the use of the disclosed reject inference techniques, according to some embodiments. For example, in the embodiment depicted in FIGS. 2A-2B, the training dataset 112 corresponds to user accounts with a server system. As a non-limiting example, this server system may be used to provide any of various suitable services (e.g., as web services) in which the computing resources of the server system (including hardware or software elements of the server system) perform computing operations on behalf of a requesting user. Non-limiting examples of services a server system may provide include email services, social media services, streaming media services, online payment services, etc.

In FIG. 2A, chart 202 graphically depicts the proportion of samples that are included in and excluded from a training dataset 112 before use of the disclosed reject inference techniques, according to one embodiment. In this non-limiting example, chart 202 includes sections for labeled data samples 114 corresponding to active user accounts and a section for unlabeled data samples 116 corresponding to dormant user accounts 208. More specifically, the labeled data samples 114 includes samples for both the non-malicious active user accounts 204 and the malicious active user accounts 206. As indicated in FIG. 2A, the training dataset 112 includes labeled data samples 114 for non-malicious active user accounts 204 and labeled data samples 114 for malicious active user accounts 206 but excludes the unlabeled data samples 116 corresponding to dormant user accounts 208, according to this non-limiting example.

Note that, in FIG. 2A, the unlabeled data samples 116 for dormant user accounts 208 constitute a significant portion (e.g., 65%, in the depicted embodiment) of the total samples (that is, the total number of labeled data samples 114 and unlabeled data samples 116 combined). As noted above, such a scenario may arise because, in some instances, a significant portion of the user accounts with a server system may be dormant. Of these dormant user accounts 208 it is likely that some (and possibly many) are malicious user accounts that, given the opportunity, will be used to perform malicious or otherwise fraudulent operations in the future. In various embodiments, however, the disclosed techniques may be used to identify at least a portion of these unlabeled data samples 116 that correspond to malicious dormant user accounts 208. Note that the numbers used in FIG. 2A are merely an example, and may vary widely according to different scenarios, however.

For example, referring to FIG. 2B, chart 252 graphically depicts the proportion of samples that are included in and excluded from an expanded training dataset 212 after the disclosed reject inference techniques have been used to identify newly labeled data samples 124 for malicious dormant user accounts 256, according to one non-limiting embodiment. In the depicted embodiment, the disclosed techniques were used to identify, from the unlabeled data samples 116 for the dormant user accounts 208, a number of newly labeled data samples 124 that correspond to malicious dormant user accounts 256. In various embodiments, these newly labeled data samples 124 may be added to the training dataset 112 to generate the expanded training dataset 212 such that the expanded training dataset 212 includes labeled data samples 114 for non-malicious active user accounts 204, labeled data samples 114 for malicious active user accounts 206, and newly labeled data samples 124 for malicious dormant user accounts 256. In the embodiment of FIG. 2B, the newly labeled data samples 124 constitute 10% of the total samples, though this embodiment is provided nearly as one non-limiting example. In this embodiment, the disclosed techniques increase the overall size of the training dataset from 35% to 45% of the total available samples and aid in balancing the distribution of the samples in the expanded training dataset 212 between the categories of malicious and non-malicious user accounts. For example, in this embodiment the addition of newly labeled data samples 124 to the expanded training dataset 212 changes the proportion of samples for non-malicious accounts to malicious accounts from a ratio of 6:1 to a ratio of 2:1, tripling the number of samples in the training dataset 112 for malicious user accounts. As noted above, this, in turn, may improve the performance of predictive models (e.g., classification model 110) trained using this expanded training dataset 212.

In FIG. 3, block diagram 300 depicts an example embodiment in which the reject inference module 102 includes an attribute selection module 304 and a rule generation module 306. In various embodiments, the attribute selection module 304 is operable to select a set of the most-common attributes 305 from the set of attributes 122 identified by the attribute identification module 106. For example, in FIG. 3 the reject inference module 102 has access to the set of attributes 122, which include attributes 302A-302N, identified by the attribute identification module 106 based on the set of unlabeled data samples 120. In various embodiments, the set of attributes 122 specify the attributes 302 of the set of unlabeled data samples 120 (e.g., specified in the respective feature vectors) that contributed to their respective model scores 118. In some embodiments, for example, the set of attributes 122 may include one or more of the attributes 302 of the corresponding unlabeled data sample 116 that contributed to that unlabeled data sample 116's model score 118. Accordingly, in some embodiments, the set of attributes 122 includes one or more attributes 302 for each of the unlabeled data samples 116 included in the set of unlabeled data samples 120. As a non-limiting example, for a given data sample in the set of unlabeled data samples 120, the set of attributes 122 may include multiple attributes 302A-302E that contributed to the model score 118 for that given data sample. In various embodiments, the attributes 302 may correspond to the features in the feature vectors of the labeled data samples 114 used to train the classification model 110.

Note that, in various embodiments an attribute 302 may specify one or more corresponding threshold values. As a non-limiting example, an attribute 302 may relate to the number of user accounts registered using a particular IP address and may include a corresponding threshold value (e.g., 6). Other non-limiting examples of attributes 302 that may include one or more corresponding threshold values include: the number of characters in the provided address exceeds 100, the number of actions taken via a particular IP address exceeds 100 in the last one-hour time period, the observed typing speed associated with the user account exceeds 100 words per minute (e.g., indicating that a script is being run to interact with the server system), etc. Further note that, in some embodiments, one or more of the attributes 302 may not include one or more threshold values and instead may be simply take on a value of “true” or “false” (or any other suitable set of values usable to indicate a state of a condition, such as the values “0” or “1”). Non-limiting examples of such attributes 302 include: the mobile communication device associated with the user account is invalid, the email address provided for the user account is gibberish, etc.

Attribute selection module 304, in the depicted embodiment, selects, from the various attributes 302A-302N the set of most-common attributes 305. For example, in some embodiments the attribute selection module 304 is operable to identify the attributes 122 that appeared most frequently for the set of unlabeled data samples 120 and select, as the most-common attributes 305, those attributes that appeared with a frequency that exceeds some threshold (e.g., the top 5% most frequent, the top 10% most frequent, etc.). In some embodiments, the attribute selection module 304 is able to narrow the number of attributes from a relatively large number (e.g., & Goetzel, P. C. thousands, tens of thousands, etc.) to a relatively small number (e.g., fifty, one hundred, etc.) of the most-common attributes 305.

Rule generation module 306, in various embodiments, is operable to generate one or more candidate policy rules 310 based on the set of most-common attributes 305. For example, in some embodiments, the rule generation module 306 may combine (e.g., using a Boolean operator such as AND, OR, XOR, etc.) two or more of the attributes 302 to generate a candidate policy rule 310. As a non-limiting example in the context of identifying malicious dormant user accounts 256, a candidate policy rule 310 may state that if the observed typing speed (e.g., during account registration) exceeds 100 words-per-minute and the mobile communication device associated with the user account has not been validated, then the user account is likely a malicious user account. Again note, however, that this candidate policy rule 310 is provided merely as one non-limiting example. Further note that, in various embodiments a candidate policy rule 310 may be based on a single attribute 302. One non-limiting example of a candidate policy rule 310 that is based on a single attribute 302 may state that if the number of user accounts registered using the observed IP address within the last 12 hours exceeds five, then the user account is likely a malicious user account. Additionally, in some embodiments, the rule generation module 306 is operable to perform the generation of candidate policy rules 310 based on user input from a user (e.g., a data scientist utilizing the disclosed reject inference techniques). For example, in some embodiments the rule generation module 306 may receive user input identifying one or more of the most-common attributes 305 to include in or exclude from the candidate policy rules 310. Additionally, in some embodiments, the user input may directly specify one or more of the candidate policy rules 310.

In FIG. 4, block diagram 400 depicts an example embodiment of reject inference module 102 that includes a rule verification module 402 and rule selection module 406, according to some embodiments. In various embodiments, the rule verification module 402 is operable to generate one or more performance metrics 404 for the candidate policy rules 310 based on the training dataset 112. Additionally, in various embodiments, the rule selection module 406 is operable to select one or more policy rules 408 from the set of candidate policy rules 310 based on the performance metrics 404.

In the depicted embodiment, training dataset 112 includes labeled data samples 114 belonging to two categories. More specifically, the training dataset 112 of FIG. 4 includes a set of labeled training samples 114A-114J belonging to a first category 410 (e.g., malicious active user accounts 206) and a set of labeled training samples 114K-114N belonging to a second category 412 (e.g., non-malicious active user accounts 204). Note, however, that this embodiment is provided merely as one non-limiting example and, in other embodiments, the training dataset 112 may include labeled training samples that belong to any suitable number of two or more categories.

In various embodiments, the rule verification module 402 is operable to evaluate one or more performance metrics 404 of the candidate policy rules 310 using the training dataset 112. For example, in various embodiments the rule verification module 402 is operable to determine the accuracy of each of the candidate policy rules 310. Consider, as a non-limiting example, an embodiment in which the candidate policy rules 310 are constructed such that they identify data samples belonging to the first category 410. In some such embodiments, the rule verification module 402 may determine one or more performance metrics of the candidate policy rules 310 by applying the candidate policy rules 310 to some (e.g., only labeled training samples 114A-114J) or all of the labeled data samples 114 in the training dataset 112. For a given candidate policy rule 310, such as candidate policy rule 310A (not separately shown, for clarity), the rule verification module 402 may determine the accuracy by dividing the number of the labeled data samples 114 that the candidate policy rule 310A correctly identified as belonging to the first category 410 by the total number of labeled training samples 114A-114J belonging to the first category 410. Additionally, in some embodiments, the rule verification module 402 is operable to determine the false positive rate of a candidate policy rule 310A based on the number of samples belonging to the second category 412 that the candidate policy rule incorrectly classifies as belonging to the first category 410. Further note that, in some embodiments, the rule verification module 402 is operable to determine one or more performance metrics 404 using the set of unlabeled data samples 120. For example, in some embodiments the rule verification module 402 may utilize the set of unlabeled samples to determine the coverage of one or more of the candidate policy rules 310 or the increase (e.g., expressed as a percentage) in the amount of labeled samples the candidate policy rules 310 produce.

In various embodiments, the rule selection module 406 is operable to select one or more policy rules 408 from the set of candidate policy rules 310 based on the performance metrics 404. For example, in some embodiments the rule selection module 406 is operable to select the policy rules 408 that have an accuracy that exceeds a particular threshold (e.g., 85%, 90%, 95%, etc.). Note, however, that this embodiment is provided merely as a non-limiting example and, in other embodiments, the rule selection module 406 is operable to select the policy rules 408 based on any other suitable performance metric 404 or any combination of two or more performance metrics 404. In one embodiment, for example, the rules selection module 406 selects the policy rules 408 based on three performance metrics: the accuracy of the policy rule, the coverage of the policy rule on the set of unlabeled data samples 120, and the increase in the number of labeled samples identified by the policy rule.

In some embodiments, the rule selection module 406 may select the policy rules 408 utilizing (instead of or in addition to the performance metrics 404) an attribute exclusion list that specifies one or more specific attributes 302 that are to be excluded from the policy rules 408 selected by the rule selection module 406. For example, in some embodiments, a user may identify one or more attributes 302 that are not desirable to include in a policy rule 408. These attributes 302 may then be added to an attribute exclusion list that the rule selection module 406 uses to filter the candidate policy rules 310 when selecting the policy rules 408. Further note that, in some embodiments, the rule selection module 406 is operable to perform the selection of the policy rules 408 based on user input from a user (e.g., a data scientist utilizing the disclosed reject inference techniques). For example, in some embodiments the rule selection module 406 may narrow down the candidate policy rules 310 based on the performance metrics 404 or the exclusion list and present this shortened list of potential policy rules to the user, who may then select one or more of the policy rules 408 to be utilized in the reject inference module 102 (e.g., by classifier 108).

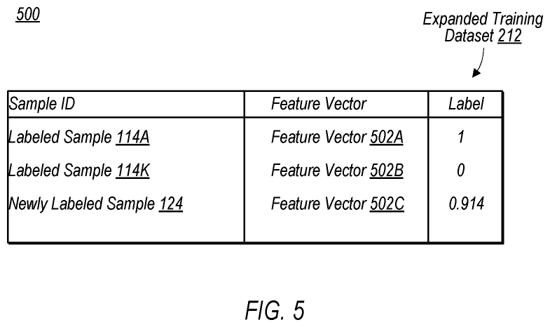

Referring now to FIG. 5, block diagram 500 depicts a portion of expanded training dataset 212, according to some embodiments. In the depicted embodiment, expanded training dataset 212 is presented in a table with three columns: a “Sample ID” column, a “Feature Vector” column, and a “Label” column, though this embodiment is provided merely as a non-limiting example and, in other embodiments, the expanded training dataset 212 may include additional, fewer, or different columns or may be represented using data structures other than a table.

In the depicted embodiment, the Sample ID column is used to represent an identifying value (e.g., an alphanumeric identifier) for a given training sample included in the expanded training dataset 212. The Feature Vector column is used to represent a feature vector of a given data sample. As noted above, the nature of the attributes included in the feature vector for a given sample will vary depending on the training data itself and the particular context in which the training data is collected. Non-limiting examples of attributes that may be included in the feature vector for a training sample in the context of identifying malicious dormant accounts are provided above. The Label column may be used to represent a classification label for the training samples in the expanded training dataset 212 to indicate the category into which the respective training samples have been classified. In some embodiments, the labels for the samples may explicitly identify the category using an alphanumeric string (e.g., malicious or “non-malicious,” “spam” or “not spam,” etc.). In other embodiments, such as that depicted in FIG. 5, the label may be provided as a numerical value that may be mapped to one of two or more categories (or, as explained below, a value that may be used to indicate a probability with which a given sample belongs to one of the two or more categories).

Block diagram 500 depicts three training samples. The first is labeled training sample 114A that has a corresponding feature vector of 502A and a label of “1.” In this non-limiting example, the expanded training dataset 212 is intended for use in a binary classification model and a label of “1” indicates that the labeled data sample 114A is classified into a first one of the two categories (e.g., malicious active user accounts 206). The second training sample is labeled training sample 114K, which has a corresponding feature vector of 502B and a label of “0,” indicating that the labeled training sample 114K is classified into a second one of the two categories (e.g., non-malicious active user accounts 204). The third training sample is newly labeled data sample 124 that, as described above, was identified using the disclosed reject inference techniques. For example, in reference to FIG. 2B, the newly labeled data sample 124 may be one of the newly labeled data samples corresponding to a malicious dormant user account 256. Newly labeled data sample 124 has a corresponding feature vector 502C.

Note that, in the embodiment of FIG. 5, newly labeled data sample 124 has a label of “0.914.” As discussed above in reference to FIG. 4, in some embodiments the classifier 108 is operable to generate a label, for a newly labeled data sample 124, that corresponds to an accuracy of the particular policy rule 408 that was used to identify the newly labeled data sample 124 from the set of unlabeled data samples 120. For example, consider an embodiment in which the rule verification module 402 determines that policy rule 408A has an accuracy of 91.4%. In such an embodiment, when the policy rule 408A is used to identify a newly labeled data sample 124, there is a 91.4% chance that this newly labeled data sample 124 belongs to the first category. Accordingly, in various embodiments, the disclosed techniques include generating a label for the newly labeled data samples 124 that correspond to the accuracy of the policy rule 408 used to identify the newly labeled data samples 124. This technique may provide various technical benefits. For example, utilizing a label that is based on the accuracy (or another performance metric 404 or combination of two or more performance metrics 404) of the policy rule 408 used to identify the newly labeled data sample 124 provides a more accurate label for that newly labeled data sample 124, acknowledging that the classification of the newly labeled data sample 124 is not certain to be correct. When a prediction model is then built based on an expanded training dataset 212 in which the newly labeled data samples 124 (or a subset thereof) have been labeled in this manner, the learning algorithm used to train the model may take these label values into account when determining the various parameters or weightage values for the model, further improving the model's performance. Note, however, that this embodiment is provided merely as one non-limiting example. In other embodiments, the classifier 108 is operable to generate labels for the newly labeled data samples 124 that identify the particular one of the two or more categories into which the newly labeled data samples 124 are being classified using an explicit label value for that category (e.g., “0,” “1,” “2,” etc.). That is, in some embodiments, the classifier 108 generates labels that are not based on the performance metrics 404 of any of the policy rules 408 used to identify the newly labeled data samples 124.

### Example Methods

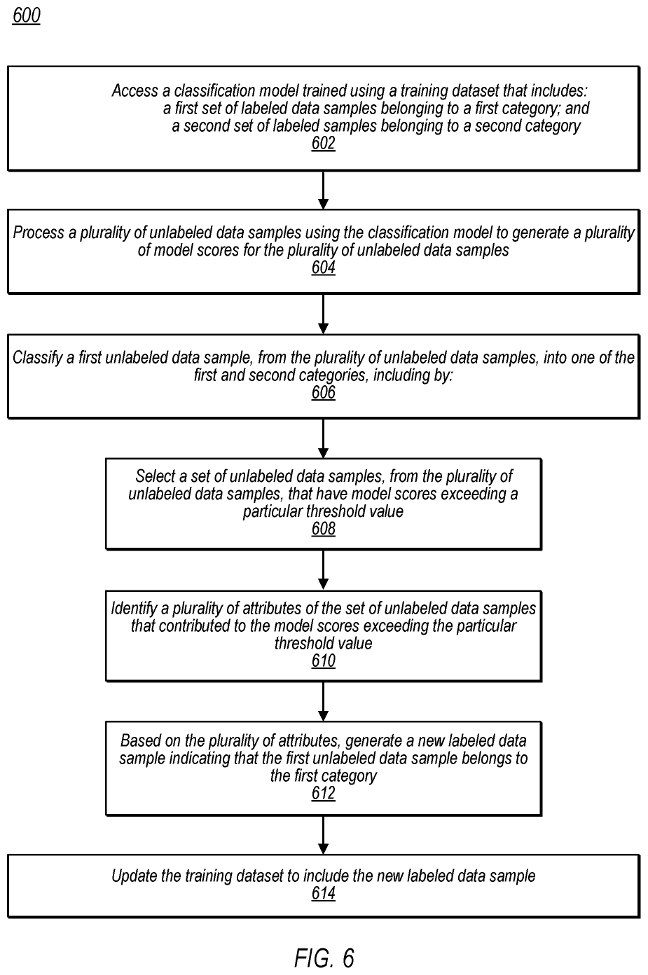

Referring now to FIG. 6, a flow diagram illustrating an example method 600 for performing reject inference using attributes of unlabeled data samples is depicted, according to some embodiments. In various embodiments, method 600 may be performed by reject inference module 102 of FIG. 1 to classify one or more newly labeled data samples 124, or by any computer system in various embodiments. In some embodiments, for example, a computer system (e.g., a server computer system) implementing the reject inference module 102 may include (or have access to) a non-transitory, computer-readable medium having program instructions stored thereon that are executable by the computer system to cause the operations described with reference to FIG. 6. In FIG. 6, method 600 includes elements 602-614. While these elements are shown in a particular order for ease of understanding, other orders may be used. In various embodiments, some of the method elements may be performed concurrently, in a different order than shown, or may be omitted. Additional method elements may also be performed as desired.

At 602, in the illustrated embodiment, the computer system accesses a classification model (e.g., a machine learning model) that was trained using a training dataset that includes a first set of labeled data samples belonging to a first category and a second set of labeled samples belonging to a second category. For example, with reference to FIGS. 1 and 2A-2B above, the computer system may access a classification model 110 that was trained using training dataset 112 that includes a first set of labeled data samples 114 belonging to the category of malicious active user accounts 206 and a second set of labeled data samples 114 that belong to the category of non-malicious active user accounts 204.

At 604, in the illustrated embodiment, the computer system processes a plurality of unlabeled data samples using the classification model to generate a plurality of model scores for the plurality of unlabeled data samples. For example, the computer system may use the classification model 110 to generate model scores 118 for unlabeled data samples 116. At 606, in the illustrated embodiment, the computer system classifies a first unlabeled data sample, from the plurality of unlabeled data samples, into one of the first and second categories. In the depicted embodiment, element 606 includes sub-elements 608-612. Note, however, that this embodiment is provided merely as one non-limiting example and, in other embodiments, element 606 may include additional, fewer, or different sub-elements than those shown in FIG. 6.

At 608, in the illustrated embodiment, the computer system selects a set of unlabeled data samples, from the plurality of unlabeled data samples, having model scores exceeding a particular threshold value. For example, as described above with reference to FIG. 1, sample selection module 104 may select, from the unlabeled data samples 116, a set of unlabeled data samples 120 for which the corresponding model scores 118 exceed a particular threshold. Stated differently, in various embodiments the sample selection module 104 is operable to select the set of unlabeled data samples 120 that, as indicated by the model scores 118, have a highest likelihood of belonging to a particular one of the plurality of categories. As one non-limiting example, in embodiments in which a higher model score 118 indicates a higher likelihood that the corresponding unlabeled data sample 116 belongs to a particular category, the sample selection module 104 may select, as the set of unlabeled data samples 120, the unlabeled data samples 116 having the highest 10% of model scores 118.

At 610, in the illustrated embodiment, the computer system identifies a plurality of attributes of the set of unlabeled data samples that contributed to the model scores exceeding the particular threshold value. For example, the attribute identification module 106 of FIG. 1 may identify the set of attributes 122 that contributed to the set of unlabeled samples 120 receiving model scores 118 that exceed a particular threshold, as described above. At 612, in the illustrated embodiment, the computer system generates a new labeled sample, based on the plurality of attributes, indicating that the first unlabeled data sample belongs to the first category. For example, in some embodiments, the classifier 108 may apply a policy rule 408 to the set of unlabeled data samples 120 to identify a first unlabeled data sample (from the set of unlabeled data samples 120) to classify as belonging to the first category. As described above with reference to FIG. 3, the attribute selection module 304 may select, from the set of attributes 122, the set of most-common attributes 305 that contributed to the model scores 118 of the set of unlabeled training samples 120 exceeding the particular threshold value. As one non-limiting example, in some embodiments the set of most-common attributes 305 includes an attribute that corresponds to the number of user accounts registered using a given IP address. In some embodiments, the policy rule 408 may be based on at least one of the set of most-common attributes 305. Further, in some embodiments, method 600 may include generating the policy rule 408 based on a combination of one or more of the set of most-common attributes 305, as described above with reference to FIG. 3.

Note that, in some embodiments, generating the new labeled data sample includes assigning the first unlabeled data sample with a label. As discussed above, in some embodiments this label may be a string that directly specifies the category into which the newly labeled data samples 124 is classified (e.g., “malicious user accounts”) or a numerical or alphanumerical value that may be mapped to one of multiple different categories (e.g., a value of “1” to indicate the newly labeled data sample 124's classification into the category of “malicious user accounts”). In other embodiments, the label assigned to the newly labeled data sample 124 may be based on one or more performance metrics of the policy rule 408 used to identify the newly labeled data sample 124. For example, in some embodiments method 600 may include verifying the policy rule 408 (e.g., by determining the accuracy of the policy rule 408 using the first set of labeled data samples 114 that belong to the first category) prior to using that policy rule 408 to classify the first unlabeled data sample, as discussed above with reference to FIG. 5. In some such embodiments, generating the new labeled data sample at element 612 includes assigning a particular label, to the first unlabeled data sample, that corresponds to the accuracy of the policy rule 408 used to identify the first unlabeled data sample.

At 614, in the illustrated embodiment, the computer system updates the training dataset to include the new labeled data sample. For example, with reference to FIG. 2B, the newly labeled data sample 124 may be included in an expanded training dataset 212, which may then be used to train the classification model 110 to generate an updated classification model. In some such embodiments, method 600 may further include classifying a new unlabeled data sample as belonging to the first category using the updated classification model.

Note that, in some embodiments, the training dataset 112 corresponds to a plurality of active user accounts with a server system, where the first category corresponds to malicious user accounts and the second category corresponds to non-malicious user accounts. Further note that, in some embodiments, the plurality of unlabeled data samples 116 correspond to a plurality of dormant user accounts with the server system. In some such embodiments, method 600 may further include identifying a first dormant user account that corresponds to the first unlabeled data sample and then performing one or more risk-mitigation operation for the first dormant user account, such as disabling particular functionality of the first dormant user account pending performance of a multi-factor authentication operation by a user of the first dormant user account.

Referring now to FIG. 7, a flow diagram illustrating an example method 700 for identifying malicious dormant user accounts using the disclosed reject inference techniques is depicted, according to some embodiments. In various embodiments, method 700 may be performed by a server system that provides a service (e.g., a web service) to remote users to identify one or more malicious dormant user accounts 256 from a set of dormant user accounts 208 with the server system. Note, however, that in other embodiments, method 700 may performed by a computer system other than or outside of the server system used to provide the service, or by the server system in combination with such an outside computer system. In some embodiments, for example, a portion of method 700 (e.g., elements 702-708) may be performed by an outside computer system (e.g., a computer system associated with a data science team or service) to identify a first unlabeled data sample to classify as belonging to a classification of malicious user accounts, and another portion of method 700 (e.g., 710-712) may be performed by the server system to perform one or more risk-mitigation operation on a corresponding dormant user account. In various embodiments, one or more computer systems (e.g., a server system, an outside computer system, or a combination thereof) may include (or have access to) a non-transitory, computer-readable medium having program instructions stored thereon that are executable by the server system to cause the operations described with reference to FIG. 7. In FIG. 7, method 700 includes elements 702-712. While these elements are shown in a particular order for ease of understanding, other orders may be used. In various embodiments, some of the method elements may be performed concurrently, in a different order than shown, or may be omitted. Additional method elements may also be performed as desired.

At 702, in the illustrated embodiment, the server system generates, using a classification model, a plurality of model scores for a plurality of unlabeled data samples, where the plurality of unlabeled data samples correspond to a plurality of dormant user accounts with a server system. For example, in some embodiments, the plurality of unlabeled data samples may correspond to some or all of the dormant user accounts 208 described above with reference to FIGS. 2A-2B. At 704, in the illustrated embodiment, the server system identifies a first unlabeled data sample, from the plurality of unlabeled data samples, to classify as belonging to a classification of malicious user accounts. In the depicted embodiment, element 704 includes sub-elements 706-708. Note, however, that this embodiment is provided merely as a non-limiting example and, in other embodiments, element 704 may include additional, fewer, or different sub-elements.

At 706, in the illustrated embodiment, the server system accesses, for a set of the unlabeled data samples with corresponding model scores in a particular range, a plurality of attributes of the set of unlabeled data samples that contributed to the corresponding model scores. For example, as described above with reference to FIG. 1, in some embodiments the server system may access a set of unlabeled data samples 120 that have corresponding model scores 118 that fall within a specified range (e.g., the top 10% of model scores 118, model scores 118 from 0.0-0.2, model scores 118 that exceed a value of 95 on a scale from 1-100, etc.). At 708, in the illustrated embodiment, the server system identifies the first unlabeled data sample based on at least one of the plurality of attributes. For example, in some embodiments, the server system may use the classifier 108 to apply one or more policy rules 408 to the set of unlabeled data samples 120 to identify a newly labeled data sample 124. Note that, in some such embodiments, the policy rule(s) 408 applied by the classifier 108 may be based on one or more of the set of attributes 122.

At 710, in the illustrated embodiment, the server system identifies a first dormant user account corresponding to the first unlabeled data sample. For example, in some embodiments the first unlabeled data sample identified at element 708 may have a corresponding identifier value (e.g., an alphanumeric identifier), which the server system may use to map that identified first unlabeled data sample to the first dormant user account on which the data sample is based. At 712, in the illustrated embodiment, the server system performs one or more risk-mitigation operations on the first dormant user account. For example, in some embodiments, the server system may disable particular functionality of the first dormant user account pending performance of a multi-factor authentication operation by a user of the first dormant user account.

### Example Computer System

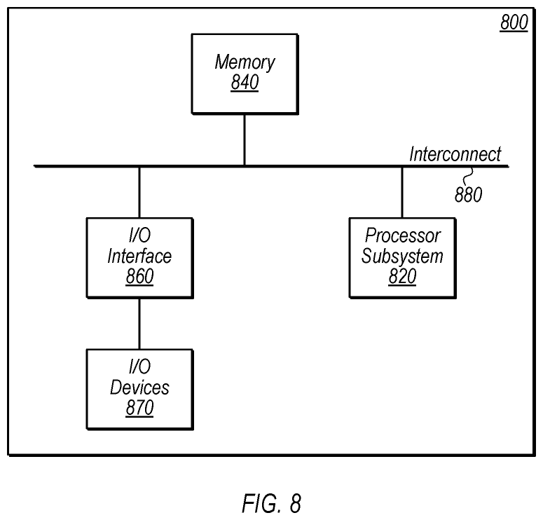

Referring now to FIG. 8, a block diagram of an example computer system 800 is depicted, which may implement one or more computer systems, such as a computer system used to implement reject inference module 102 of FIG. 1, according to various embodiments. Computer system 800 includes a processor subsystem 820 that is coupled to a system memory 840 and I/O interfaces(s) 860 via an interconnect 880 (e.g., a system bus). I/O interface(s) 860 is coupled to one or more I/O devices 870. Computer system 800 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 800 is shown in FIG. 8 for convenience, computer system 800 may also be implemented as two or more computer systems operating together.

Processor subsystem 820 may include one or more processors or processing units. In various embodiments of computer system 800, multiple instances of processor subsystem 820 may be coupled to interconnect 880. In various embodiments, processor subsystem 820 (or each processor unit within 820) may contain a cache or other form of on-board memory.

System memory 840 is usable to store program instructions executable by processor subsystem 820 to cause system 800 perform various operations described herein. System memory 840 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 800 is not limited to primary storage such as system memory 840. Rather, computer system 800 may also include other forms of storage such as cache memory in processor subsystem 820 and secondary storage on I/O devices 870 (e.g., a hard drive, storage array, etc.). In some embodiments, these other forms of storage may also store program instructions executable by processor subsystem 820.

I/O interfaces 860 may be any of various types of interfaces configured to couple to and communicate with other devices, according to various embodiments. In one embodiment, I/O interface 860 is a bridge chip (e.g., Southbridge) from a front-side to one or more back-side buses. I/O interfaces 860 may be coupled to one or more I/O devices 870 via one or more corresponding buses or other interfaces. Examples of I/O devices 870 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 870 includes a network interface device (e.g., configured to communicate over WiFi, Bluetooth, Ethernet, etc.), and computer system 800 is coupled to a network via the network interface device.

### ***

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

Unless stated otherwise, the specific embodiments described herein are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

Particular features, structures, or characteristics may be combined in any suitable manner consistent with this disclosure. The disclosure is thus intended to include any feature or combination of features disclosed herein (either explicitly or implicitly), or any generalization thereof. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

For example, while the appended dependent claims are drafted such that each depends on a single other claim, additional dependencies are also contemplated, including the following: Claim 3 (could depend from any of claims 1-2); claim 4 (any preceding claim); claim 5 (claim 4), etc. Where appropriate, it is also contemplated that claims drafted in one statutory type (e.g., apparatus) suggest corresponding claims of another statutory type (e.g., method).

### ***

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to the singular forms such “a,” “an,” and “the” are intended to mean “one or more” unless the context clearly dictates otherwise. Reference to “an item” in a claim thus does not preclude additional instances of the item.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” covering x but not y, y but not x, and both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one of element of the set [w, x, y, z], thereby covering all possible combinations in this list of options. This phrase is not to be interpreted to require that there is at least one instance of w, at least one instance of x, at least one instance of y, and at least one instance of z.

Various “labels” may proceed nouns in this disclosure. Unless context provides otherwise, different labels used for a feature (e.g., “first circuit,” “second circuit,” “particular circuit,” “given circuit,” etc.) refer to different instances of the feature. The labels “first,” “second,” and “third” when applied to a particular feature do not imply any type of ordering (e.g., spatial, temporal, logical, etc.), unless stated otherwise.

Within this disclosure, different entities (which may variously be referred to as “units,” “circuits,” other components, etc.) may be described or claimed as “configured” to perform one or more tasks or operations. This formulation “[entity] configured to [perform one or more tasks]” is used herein to refer to structure (i.e., something physical). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function. This unprogrammed FPGA may be “configurable to” perform that function, however,

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for [performing a function]” construct.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

In this disclosure, various “modules” operable to perform designated functions are shown in the figures and described in detail (e.g., reject inference module 102, sample selection module 104, attribute identification module 106, classifier 108, etc.). As used herein, a “module” refers to software, hardware, or a combination thereof that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC.

What is claimed is:

1. A method, comprising:
accessing, by a computer system, a machine learning classification model trained using a training dataset that includes:
a first set of labeled data samples belonging to a first category; and
a second set of labeled data samples belonging to a second category;
processing, by the computer system, a plurality of unlabeled data samples using the machine learning classification model to generate a plurality of model scores for the plurality of unlabeled data samples, wherein, for a given one of the plurality of unlabeled data samples, a corresponding model score indicates a probability that the given unlabeled data sample belongs to the first category;
classifying, by the computer system, a first unlabeled data sample, from the plurality of unlabeled data samples, into one of the first and second categories, including by:
selecting a set of unlabeled data samples, from the plurality of unlabeled data samples, that have model scores exceeding a particular threshold value;
identifying a plurality of attributes of the set of unlabeled data samples that contributed to the model scores exceeding the particular threshold value; and
based on the plurality of attributes, generating a new labeled data sample indicating that the first unlabeled data sample belongs to the first category; and
updating, by the computer system, the training dataset to include the new labeled data sample.

2. The method of claim 1, wherein the classifying the first unlabeled data sample further includes:
selecting, from the plurality of attributes, a set of most-common attributes of the set of unlabeled data samples that contributed to the model scores exceeding the particular threshold value; and
applying a policy rule to the set of unlabeled data samples to identify the first unlabeled data sample, wherein the policy rule is based on at least one of the set of most-common attributes of the set of unlabeled data samples.

3. The method of claim 2, further comprising:
prior to classifying the first unlabeled data sample, verifying, by the computer system, the policy rule using the training dataset, wherein the verifying includes determining an accuracy of the policy rule using the first set of labeled data samples that belong to the first category.

4. The method of claim 3, wherein generating the new labeled data sample includes assigning a particular label, to the first unlabeled data sample, that corresponds to the accuracy of the policy rule.

5. The method of claim 2, further comprising:
generating, by the computer system, the policy rule based on a combination of one or more of the set of most-common attributes of the set of unlabeled data samples.

6. The method of claim 1, wherein the training dataset corresponds to a plurality of active user accounts with a server system, and wherein the plurality of unlabeled data samples correspond to a plurality of dormant user accounts with the server system.

7. The method of claim 6, wherein the first category corresponds to malicious user accounts and the second category corresponds to non-malicious user accounts, wherein the method further comprises:
identifying, by the computer system, a first dormant user account corresponding to the first unlabeled data sample; and
performing, by the computer system, one or more risk-mitigation operations for the first dormant user account.

8. The method of claim 7, wherein the one or more risk-mitigation operations include disabling particular functionality of the first dormant user account pending performance of multi-factor authentication by a user of the first dormant user account.

9. The method of claim 2, wherein the set of most-common attributes includes a number of user accounts registered using a given IP address.

10. The method of claim 1, further comprising:
training, by the computer system, the machine learning classification model based on the updated training dataset to generate an updated machine learning classification model; and
classifying, by the computer system, a new unlabeled data sample as belonging to the first category using the updated machine learning classification model.

11. A non-transitory, computer-readable medium having instructions stored thereon that are executable by a computer system to perform operations comprising:
accessing a machine learning model trained using a training dataset that includes:
a first set of labeled data samples belonging to a first category; and
a second set of labeled data samples belonging to a second category;
processing a plurality of unlabeled data samples using the machine learning model to generate a plurality of model scores for the plurality of unlabeled data samples, wherein, for a given one of the plurality of unlabeled data samples, a corresponding model score indicates a probability that the given unlabeled data sample belongs to the first category;
classifying a first unlabeled data sample, from the plurality of unlabeled data samples, into one of the first and second categories, including by:
selecting a set of unlabeled data samples, from the plurality of unlabeled data samples, that have model scores exceeding a particular threshold value;
identifying a plurality of attributes of the set of unlabeled data samples that contributed to the model scores exceeding the particular threshold value; and
based on the plurality of attributes, generating a new labeled data sample indicating that the first unlabeled data sample belongs to the first category; and
updating the training dataset to include the new labeled data sample.

12. The non-transitory, computer-readable medium of claim 11, wherein the classifying the first unlabeled data sample further includes:
selecting, from the plurality of attributes, a set of most-common attributes of the set of unlabeled data samples that contributed to the model scores exceeding the particular threshold value; and
applying a policy rule to the set of unlabeled data samples to identify the first unlabeled data sample, wherein the policy rule is based on at least one of the set of most-common attributes of the set of unlabeled data samples.

13. The non-transitory, computer-readable medium of claim 12, wherein the operations further comprise:
prior to classifying the first unlabeled data sample, verifying the policy rule using the training dataset, wherein the verifying includes determining an accuracy of the policy rule using the first set of labeled data samples that belong to the first category; and
wherein generating the new labeled data sample includes assigning a particular label, to the first unlabeled data sample, that corresponds to the accuracy of the policy rule.

14. The non-transitory, computer-readable medium of claim 11, wherein the plurality of unlabeled data samples correspond to a plurality of dormant user accounts, and wherein the operations further comprise:
identifying a first dormant user account corresponding to the first unlabeled data sample; and
performing one or more risk-mitigation operations for the first dormant user account.

15. The non-transitory, computer-readable medium of claim 11, wherein the operations further comprise:
training the machine learning model based on the updated training dataset to generate an updated machine learning model; and
classifying a new unlabeled data sample as belonging to the first category using the updated machine learning model.

16. A method, comprising:
training, by a computer system, a classification model using a training dataset that corresponds to a plurality of active user accounts with a server system, wherein the training dataset includes:
a first set of labeled data samples corresponding to malicious user accounts; and
a second set of labeled data samples corresponding to non-malicious user accounts;
processing, by the computer system, a plurality of unlabeled data samples using the classification model to generate a plurality of model scores, wherein the plurality of unlabeled data samples correspond to a plurality of dormant user accounts with the server system;
classifying, by the computer system, a first unlabeled data sample, from the plurality of unlabeled data samples, as one of the malicious user accounts or the non-malicious user accounts, including by:
accessing, for a set of the plurality of unlabeled data samples with corresponding model scores in a particular range, a plurality of attributes of the set of unlabeled data samples that contributed to the corresponding model scores; and
identifying the first unlabeled data sample using a policy rule that is based on at least one of the plurality of attributes;
generating, by the computer system, a new labeled data sample that labels the first unlabeled data sample as one of the malicious user accounts; and
retraining, by the computer system, the classification model using an expanded training dataset that includes the new labeled data sample.

17. The method of claim 16, wherein the classification model is a binary classification model, and wherein the classifying the first unlabeled data sample further includes:
identifying, from the plurality of attributes, a set of most-common attributes of the set of unlabeled data samples that contributed to the corresponding model scores, wherein the at least one attribute is included in the set of most-common attributes.

18. The method of claim 17, prior to classifying the first unlabeled data sample, verifying, by the computer system, the policy rule using the training dataset, wherein the verifying includes determining an accuracy of the policy rule using the first set of labeled data samples.

19. The method of claim 18, wherein generating the new labeled data sample includes assigning a particular label, to the first unlabeled data sample, that corresponds to the accuracy of the policy rule.

20. The method of claim 16, wherein the computer system is included in the server system, and wherein the method further comprises:
identifying a first dormant user account corresponding to the first unlabeled data sample; and
performing one or more risk-mitigation operations for the first dormant user account.
